(19) United States
(12) Patent Application Publication
(10) Pub. No.: US 2008/0313319 A1
(43) Pub. Date: Dec. 18, 2008

(54) System and method for providing multi-protocol access to remote computers

(75) Inventor: Steven Geffin, N. Miami Beach, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Avocent Huntsville Corporation, Huntsville, AL (US)

(21) Appl. No.: 11/812,299

(22) Filed: Jun. 18, 2007

(51) Int. Cl. G06F 15/173

(52) U.S. Cl. 709/223

(57) ABSTRACT

A remote administration system's ability to communicate with remote computers using in-band communications is contingent on many factors (e.g., the operability of the network over which the in-band communications is carried and, to some extent, the correct operation of the software on the remote computer). Accordingly, there may come a time (e.g., during a network outage) where the remote administration system can no longer communicate with the remote computer over the preferred communications protocol (e.g., using in-band communications). In such a case, a status detector of the remote administration system may detect that an error has occurred (e.g., by “pinging” the remote computer and getting no response or by losing an open network connection) and then switch to a less preferred communications protocol (e.g., using out-of-band communications).

### FIELD OF INVENTION

The present invention is directed to a method and system for providing multi-protocol access to remote computers, and in one embodiment to a method and system for providing in-band and out-of-band access to a remote computer with automatic failover between the two types of access.

### DISCUSSION OF THE BACKGROUND

U.S. patent application Ser. No. 10/881,211 discloses, as described in its abstract, a system and method for out-of-band network management wherein one or more different management interfaces are converted into a common format management data. In that application, a number of various communications protocols can be used to communicate between a remote administration system and the computer(s) being monitored. The entire contents of that application are incorporated herein by reference.

### BRIEF DESCRIPTION OF THE DRAWINGS

The following description, given with respect to the attached drawings, may be better understood with reference to the non-limiting examples of the drawings, wherein:

FIG. 1 is a representation of a prior art remote administration system that provides multiple potential access routes to communicate with at least one remote computer;

FIG. 2 is a representation of a remote administration system that utilizes automatic failover to provide out-of-band access to a remote computer when in-band access becomes unavailable;

FIG. 3 is a representation of a remote administration system that utilizes automatic failover to provide out-of-band access to a remote computer via a shared converter when in-band access becomes unavailable;

FIG. 4 is a representation of a remote administration system that utilizes automatic failover to provide out-of-band access to a remote computer via a shared converter and multiple levels of connections when in-band access becomes unavailable; and

FIG. 5 is a representation of a remote administration system that utilizes automatic failover to provide out-of-band access to a remote computer via a shared converter when in-band access becomes unavailable.

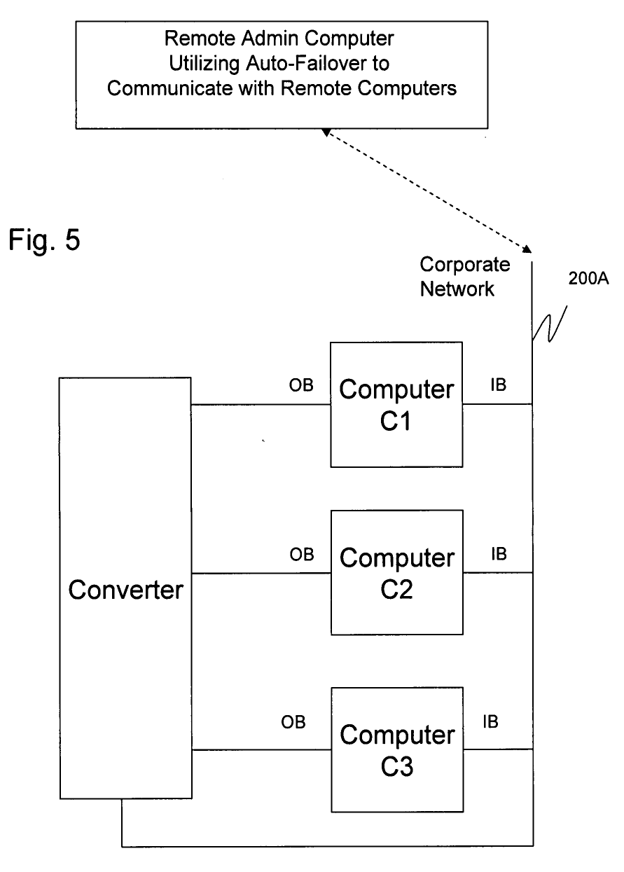

### DISCUSSION OF THE PREFERRED EMBODIMENTS

In systems such as those disclosed in U.S. patent application Ser. No. 10/881,211, a remote administrator can configure his/her computer to select from one of a plurality of different connection protocols when attempting to connect to remote computers which he/she is administering. The protocols may be either in-band protocols, that rely on the computer's normal communication network, or out-of-band protocols, that rely on alternative communication connections. Examples of in-band management tools include HP OPEN VIEW IBM TIVOLI, BMC PATROL, and CA UNICENTER remote computer management products. The in-band management tools generally rely on network protocols, such as Simple Network Management Protocol (SNMP), which are commonly used to manage large networks. Use of in-band management tools can reduce the needed hardware required to remotely manage computer systems as the computer being monitored can be at least partially responsible for transmitting its own keyboard, video and mouse signals to the remote administration system. Such systems may also benefit from the ability to upgrade the monitored system's software without the need for a hardware upgrade as might be needed with an out-of-band-solution. Such systems may also provide information between the remote administration system and the remotely monitored system that is not available in out-of-band communications.

However, in-band tools become ineffective whenever the data network associated with the network nodes fails or a managed device loses network connectivity. Thus, these in-band network management tools leave network administrators in a deadlock position (e.g., the device fails and brings the data network down and the administrator cannot reach the device because the data network is down). Examples of common causes of the deadlock position include software crashes, configuration errors, hardware malfunctions caused by power surges, need to upgrade firmware and/or network failures. Thus, failures that cause the network node to be disconnected from the data network require a human operator to travel to the location where the network node is located so that the human operator can interact with the piece of failing equipment through a terminal directly connected to a management port or actuate physical control switches to restore functionality of the failing equipment. The need to have a human operator travel to the location of the network node is expensive, causes a great amount of time to be spent by the human operator, and causes business losses by causing long data network downtime.

To overcome this limitation of in-band network management tools, systems can use out-of-band management ports and other control functions, such as power-cycling, monitoring of temperature and other health indicators, without the need for a human operator to physically travel to the location where the incident occurred. Typically, the physical interfaces for out-of-band access includes serial consoles, KVM ports, power circuits, temperature and humidity probes and/or remote actuators. While effective, the building of an alternative, independent network using different connection media for out-of-band access increases the cost of building a data center.

In an effort to standardize the physical interface and reduce the cost of out-of-band access, an industry consortium has developed an interface called Intelligent Platform Management Interface (IPMI). Other vendors have created similar proprietary interfaces. For example, HP has its INTEGRATED LIGHTS-OUT (ILO) management interface and Sun Microsystems has its ADVANCED LIGHTS OUT MODULE (ALOM) management interface. The protocols for these interfaces are well known. These out-of-band management interfaces can only be used with certain types of network nodes and define a protocol above TCP/IP and utilize common Ethernet media for transport of the management information.

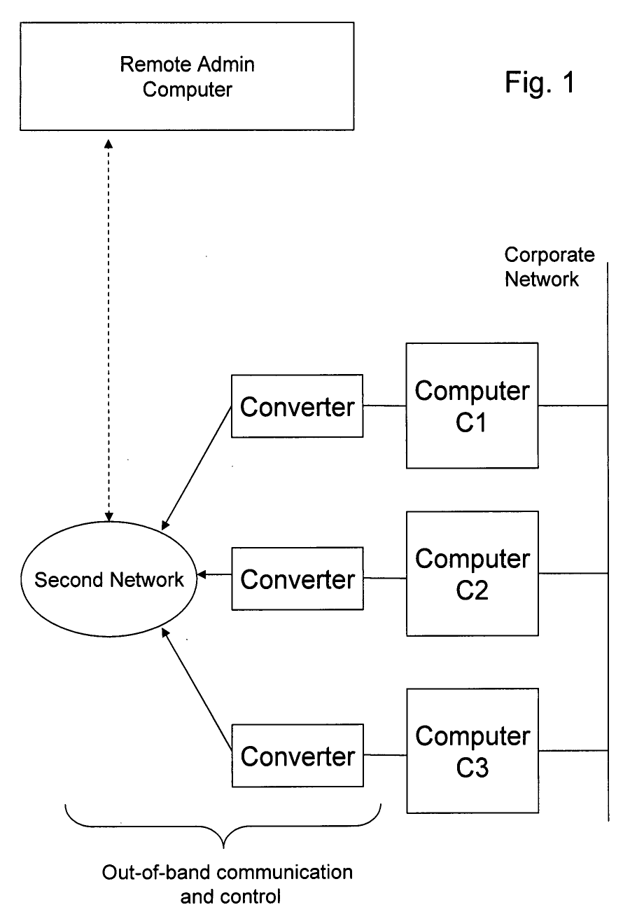

As shown in FIG. 1, and as described in U.S. Pat. No. 6,681,250, it is possible to provide remote access to a computer system using a maintenance network while the computer itself utilizes its own corporate network (LAN/WAN). This results in there being two independent communication paths that couple to the same remotely administered computer. The entire contents of that patent are incorporated herein by reference.

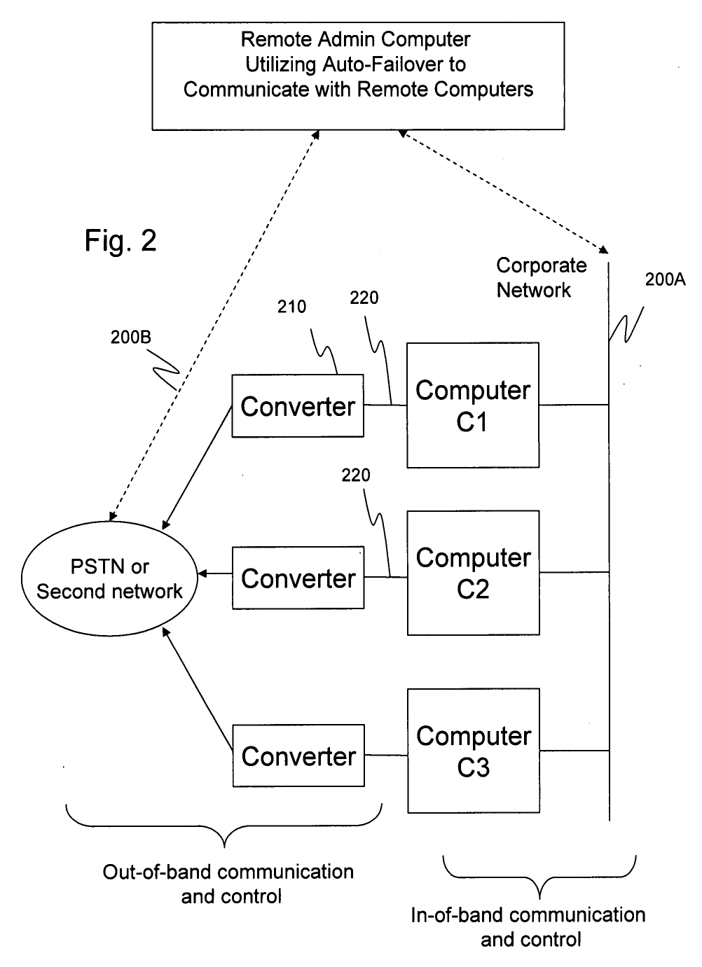

Turning to FIG. 2, it is possible to take advantage of two independent communication paths that couple to the same remotely administered computer in order to automatically switch between both in-band and out-of-band communications. Selection of which protocol to be used can be determined based on user customization and/or automatic detection of a failure of a more preferred communications protocol. For example, as shown in FIG. 2, three computers (i.e., computers C1, C2 and C3) each can communicate with a remote administration system using in-band communication over a first communications network 200A (e.g., a corporate network such as a LAN or a WAN) or using out-of-band communication over a second communications network 200B. Because of the different information carried in each of the types of communications and because of the different formats of some of the common information carried in each of the types of communications, the remote administration computer/system includes various protocol “processors” which process the information associated with their respective protocols. These processors can be either hardware processors, or software processors or a combination of hardware and software without departing from the teachings herein. Example hardware processors include ASICs, FPGAs and microprocessors.

Using the in-band communication, the remote administration system may receive keyboard, video and mouse information as well as any other information that can be sent via in-band communications. Such other information may include information known to the computers (C1, C2 and C3) but which cannot be communicated over the out-of-band connection. Because of this additional information, or for any other reason, a user of the remote administration system may elect to preferably administer one or more of the computers (e.g., C1, C2 or C3) via an in-band communications protocol.

However, while a user may prefer to use in-band communication, the remote administration system's ability to communicate with the illustrated remote computers using in-band communications is contingent on many factors (e.g., the operability of the network over which the in-band communications is carried and, to some extent, the correct operation of the software on the remote computer). Accordingly, there may come a time (e.g., during a network outage) where the remote administration system can no longer communicate with the remote computer over the preferred communications protocol (e.g., using in-band communications). In such a case, a status detector of the remote administration system may detect that an error has occurred (e.g., by “pinging” the remote computer and getting no response or by losing an open network connection) and then switch to a less preferred communications protocol (e.g., using out-of-band communications).

Alternatively, in the case of a remote computer “crashing” and becoming incapable of sending its own keyboard, video, and mouse signals over an in-band connection, the status detector of the remote administration system may detect that it has not received any data (e.g., keyboard, video or mouse data) from the remote computer within a set period of time and switch to a less preferred communications protocol (e.g., using out-of-band communications). Using out-of-band communication, the administration system can then connect to a converter 210 that is connected to a corresponding computer (e.g., using conventional KVM connections 220). By using this out-of-band communications, the administrator at the remote administration computer may see the state of the machine during times when the in-band software is not available (e.g., after crashes or during power-up).

Each of the converters of FIG. 2 is separately addressable (e.g., via IP addresses or similar packet-switched addresses) such that their corresponding computers can be accessed and/or controlled via the connections to those computers. Such connections may include, but are not limited to, keyboard, video and mouse connections over respective keyboard, video and mouse cables. In an alternate embodiment, a peripheral connection (e.g., such as a USB connection) may be made between a converter and its corresponding computer for passing a combination of data types (e.g., keyboard, video and mouse (KVM) data) between the converter and a computer. In addition, the peripheral connection can send non-KVM data, such as data for a printer and/or audio data. Using the peripheral connection, or a connection using a different communication protocol, other data, such as IPMI-data, may be transferred between the converter and a computer. While not shown, there may be firewalls, gateways or network translation devices between the remote administration system and the converters. Similarly, gateways and/or bridges may be connected between the in-band and out-of-band networks so as to selectively link the two networks.

A preference setting interface (e.g., a command line interface, a custom graphical user interface or a web interface) specifies the relative preferences between the various communications protocols. Although the relative preferences described above set the in-band communication protocol to be of a higher preference than the out-of-band communication protocol, the reverse is also possible.

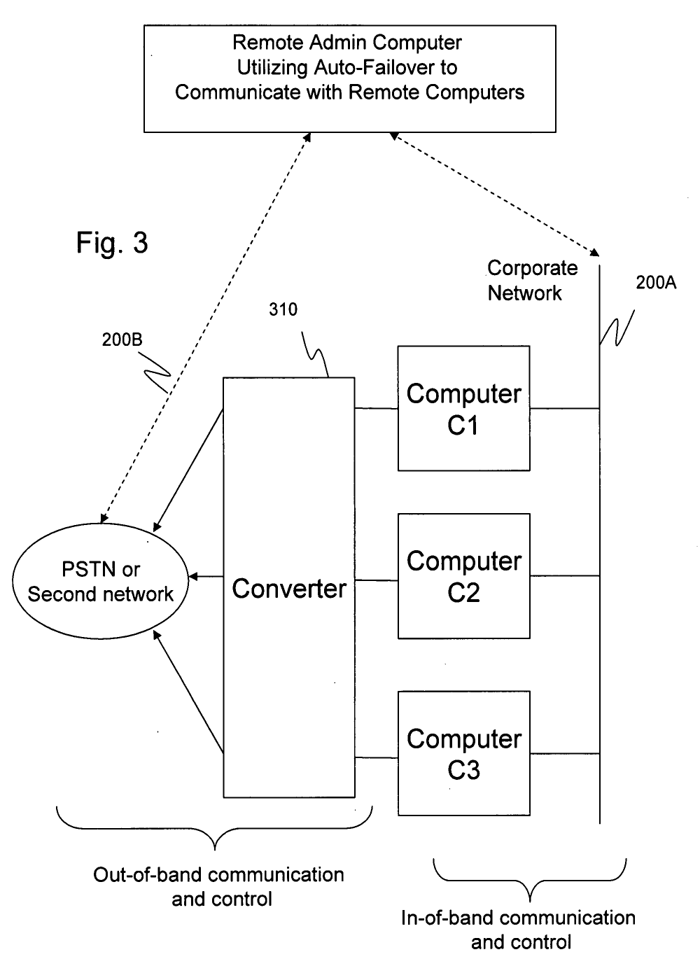

Although separate converters 210 were illustrated with respect to FIG. 2, as shown in FIG. 3, a shared converter 310 (e.g., a KVM over IP switch) can be connected to plural computers such that those computers can be remotely administered using in-band and/or out-of-band communications. In the event that a remote administration system is to communicate with a remote computer using out-of-band communications, the remote administration system sends commands to the shared converter 310 which include the sub-address of the computer with which communication is to occur. The converter then passes the commands on to the correct computer by interpreting the sub-address. In order to facilitate use of the shared converter 310, the remote administration system is programmed with information specifying the in-band and out-of-band paths to each of the managed computers such that the remote administration system can automatically switch between protocols as needed.

In addition to the other methods described above for determining when a remote administration system should switch between protocols, the switch can also occur based on a request received from a converter 210 or 310. For example, if the converter detects a specified output on a video connection (e.g., mostly a blue screen) of a computer which has been specified as a computer running MICROSOFT WINDOWS operating system, the converter may automatically send a message to the status detector of the remote administration system over the out-of-band communication channel. Similarly, if a computer (e.g., C1) detects an error condition (e.g., a failed network card) that may not have been detected by the remote administration system yet, the computer may send a message (e.g., using a peripheral connection such as a USB connection) to its associated converter 210 or 310 such that the converter may automatically send a message to the remote administration system over the out-of-band communication channel. The status detector of the remote administration system may even detect degradations in performance which would warrant a change from a more preferred protocol to a less preferred protocol. The status detector may also detect that a status has changed such that communication using the more preferred communications protocol is possible again (e.g., after the repair of a network or a network card or after the rebooting of a crashed computer). The status detector may also respond to a command (e.g., a mouse or keyboard command) of a user or the expiration of a particular time period.

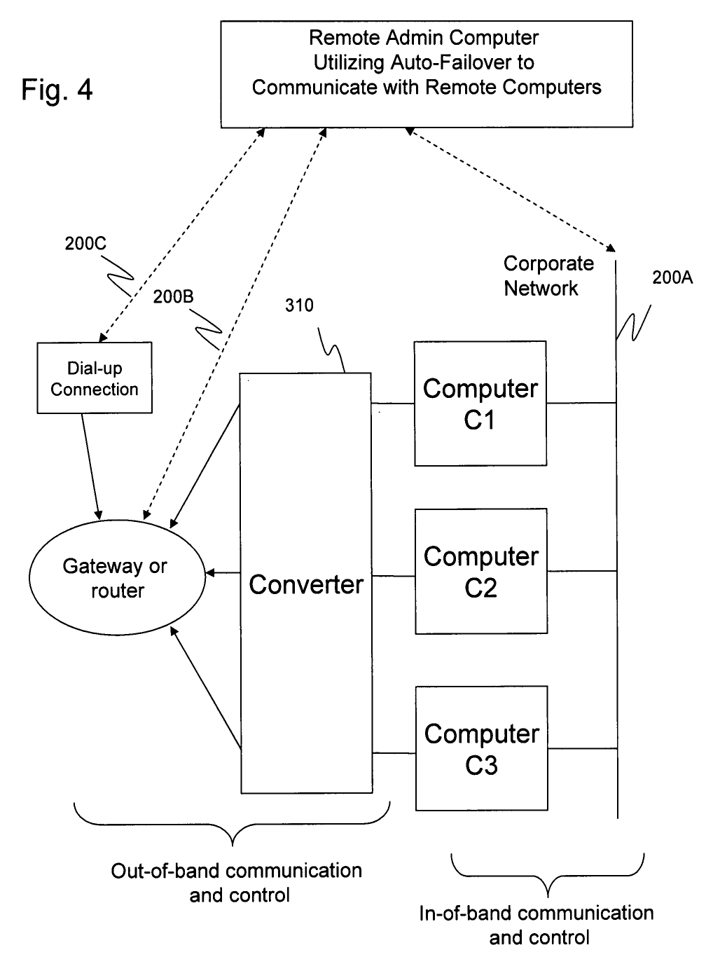

While the above has described a two-level set of preferences for connecting a remote computer to a remote administration system, several levels of preference may instead be used. For example, as shown in FIG. 4, a preference setting interface of a remote administration system may utilize a three-level hierarchy of communications preferences. As a first preference, an administrator sets that the remote administration computer should connect to a specific computer (e.g., C1) using an in-band connection to C1's IP address. The administrator further sets that a second highest preference is for the remote administration computer to connect to that same computer (e.g., C1) using an out-of-band connection to the IP address of the shared converter 310 using any packet routing (e.g., via the Internet) that is accessible to the administration system. The administrator further sets that C1 is connected to the first connection(s) of the converter 310. Lastly, the administrator sets that a third highest preference is for the remote administration computer to connect to that same computer (e.g., C1) using an out-of-band connection to the IP address of the shared converter 310 using a dial-up gateway at a specified phone number. Thus, even if a company's Internet service has stopped, the administrator can still get in by a “back door.” The administrator further sets that C1 is connected to the first connection(s) of the converter 310.

Communication between a converter 210 or 310 and a computer need not be via peripheral connections or by any physical connections. The converter 210 or 310 and its computer may communicate over Ethernet cable and/or wirelessly. For example, the converter 210 or 310 and its computer may communicate over wireless USB. The converter 210 or 310 may also be connected optically.

While certain configurations of structures have been illustrated for the purposes of presenting the basic structures of the present invention, one of ordinary skill in the art will appreciate that other variations are possible which would still fall within the scope of the appended claims.

1. An administration system for managing a remote computer by selectively using an in-band communication protocol and an out-of-band communication protocol, the system comprising:
a preference setting interface for selecting a relative preference between the in-band communication protocol and the out-of-band communication protocol;
a first communications protocol processor for communicating with the remote computer using the communication protocol having a higher relative performance;
a status detector for detecting an operational status of the remote computer; and
a second communications protocol processor for communicating with the remote computer using the communication protocol having a lower relative performance when the status detector detects that the operational status of the remote computer indicates that a change should occur.

2. The administration system as claimed in claim 1, wherein the status detector detects a time since the last arrival of at least one of keyboard, mouse and video data over the communication protocol having a higher relative performance.

3. The administration system as claimed in claim 1, wherein the status detector detects a network error.

4. The administration system as claimed in claim 1, wherein the status detector detects a closed network connection.

5. The administration system as claimed in claim 1, wherein the status detector detects a message from converter connected to the remote computer.

6. The administration system as claimed in claim 1, wherein the first and second communications protocol processors communicate over different communications networks.

7. The administration system as claimed in claim 1, wherein the first and second communications protocol processors communicate over the same communications network.

8. The administration system as claimed in claim 1, wherein the status detector detects a further change in the operational status of the remote computer; and
wherein the remote administration system switches back to the first communications protocol processor for communicating with the remote computer based on the further change in the operational status of the remote computer.
